(19) United States
(12) Patent Application Publication
(10) Pub. No.: US 2026/0049840 A1
(43) Pub. Date: Feb. 19, 2026

(54) METHOD FOR SEGMENTING TRAJECTORIES OF RECORDING RUNS

(71) Applicants: ROBERT BOSCH GMBH, Stuttgart (DE); CARIAD SE, Wolfsburg (DE)

(72) Inventors: Raphael DIZIOL, Kandel (DE); Andre-Marcel HELLMUND, Hockenheim (DE)

(21) Appl. No.: 19/299,514

(22) Filed: Aug. 14, 2025

(30) Foreign Application Priority Data
Aug. 15, 2024 (DE) 10 2024 123 349.4

(51) Int. Cl. G01C 21/00

(52) U.S. Cl. CPC G01C 21/3848

(57) ABSTRACT

Method for segmenting a trajectory (1) of a recording run (2) for the swarm-data-based compilation of HD maps, sensor data being acquired along the trajectory (1) during the recording run (2), and the sensor data being able to include GNSS measurement data, comprising the following steps:
a) detecting points (4) on the trajectory (1) at which position determination is not possible using GNSS measurement data alone or the accuracy of the position determined using GNSS measurement data alone does not attain a predetermined positioning accuracy, and
b) segmenting the trajectory (1) into multiple segments (3) in such a way that each segment (3) attains a predetermined minimum length (5) and that at least one point (4) detected in step a) is located neither in the start region (6) nor in the end region (7) of each segment (3).

### PRIOR ART

The method described here relates to the generation of digital high-resolution map data (so-called HD maps), which can be used for highly automated and possibly autonomous driving applications.

Digital maps play a crucial role in performing assisted and automated driving functions in vehicles. Digital maps are datasets that describe the situation along a route of the motor vehicle and that, as a supplement to real-time environment data, enable significantly improved performance of assisted and automated driving functions in the vehicle over what would be possible merely on the basis of real-time environment data.

Such digital maps include (in contrast to simpler digital navigation maps used by road navigation systems for road navigation) data relating to the situation in the immediate surroundings of the route that, in a sense, permit the assisted and automated driving functions to look beyond the visibility horizon of the environment sensor system in the vehicle and to be able to better assess and evaluate the environment data obtained using the environment sensor system in the vehicle. If the environment sensor system has detected, for example, a specific traffic situation in the immediate surroundings of the vehicle, then this situation can be better assessed using data from a digital map that describes the continuation of the road. For example, conclusions can be drawn as to how the traffic situation is likely to develop during the onward journey along the road.

Such digital maps routinely include a significant volume of data describing the route and the immediate surroundings thereof, such as historical data for the route and the road markings, data relating to objects in the surroundings of the route, the road topology and geometric information at lane level, and also information on the semantic context, for example traffic signs and traffic light positions. The accuracy of information and wealth of information in such maps routinely exceeds the amount of information that can be acquired using sensors alone. Extracting comprehensive semantic information directly from raw sensor data in real time is a major challenge, especially in complex traffic scenarios. By using digital maps that include the data mentioned by way of illustration, the environment data obtained using environment sensors can be enriched and evaluated more efficiently. In particular, the use of digital maps means that, in many situations, or for much information, it is merely necessary for the information contained in digital maps to be correctly evaluated on the basis of the sensor data.

Such digital maps (unlike simple digital navigation maps used by road navigation maps for road navigation) are routinely not available in a standard format for the entire road network. Such digital maps are provided by a wide variety of service providers. Unlike simple digital navigation maps, such digital maps are often also not available in a fixed, standard global coordinate system. The data on which such digital maps are based are often acquired by way of test runs by vehicles along routes/roads. To describe the position of the data in the map, very individual coordinate systems are often used, each of which refers, for example, to the position and, if necessary, the alignment of the vehicle that carried out the test run. In this case, there is a coordinate system that is referenced to the route. It is often not possible to exactly convert the digital maps, or the position information contained in the digital maps for individual objects, into a standard global coordinate system. This is often due to the fact that, during the acquisition of the data on which the digital map is based, no exact positions are available that would be necessary to convert position information into a global coordinate system, for example because no GNSS signal is available or the quality of the GNSS during acquisition is insufficient to determine an exact positioning. A very typical example would be a digital map describing the surroundings of a motor vehicle in a tunnel. No GNSS at all is available here. Nevertheless, digital maps are required for assisted and automated driving functions in such a situation.

The method described here relates to the processing and conditioning of data collected in a swarm-based manner for creating and updating high-resolution digital maps-in particular so-called HD maps. First creation (production) of an HD map and update thereof are different tasks, but they have many similarities, especially when it comes to collecting the data required for production and/or update first. Where the text below refers to production of an HD map, this generally also refers to update and vice versa.

Traditionally, high-resolution maps are created for highly automated and possibly autonomous driving applications by virtue of manufacturer-specific fleets recording data for mapping, or other sources of information being used to obtain data.

Today, this traditional approach presents typical map providers with two fundamental challenges, namely the options for providing map updates and the difficulty of collecting sufficient data for very high accuracy (granularity) of the maps. Both challenges are related to the fleet size of the vehicle fleet that collects the data processed for the map. The data collected thus far by typical map providers is routinely only sufficient for mapping with a granularity that is customary for the operation of typical navigation systems in vehicles. Such maps are commonly also referred to as SD maps. Highly autonomous and possibly even autonomous driving functions require maps that include data for each individual lane of a road and in addition also describe the environment of a road in detail. Such maps are commonly grouped together under the term “HD map” already introduced above.

In order to address the two problems of sufficiently frequent map updates and sufficient granularity of the map, approaches have recently been discussed to create maps on the basis of swarm data. Swarm data are preferably collected indirectly by the customers of vehicle manufacturers—i.e. by each individual car driver operating a vehicle. In everyday driving, sensor data from the vehicles are sent to the vehicle manufacturer and delivered to the map service provider. The map service provider processes these data to compile highly accurate HD maps.

Producing HD maps from such swarm data is a complex process that customarily takes place in multiple steps. The data processing effort for compiling HD maps from swarm data is routinely very high. In principle, measures that can be used to reduce this data processing effort are desirable.

An important step is the so-called segmentation of the data collected in a swarm-based manner. This segmentation produces processable data sections from the data collected in a swarm-based manner, which data sections can be processed to compile and/or update an HD map.

It is the object of the method described here to disclose a particularly advantageous method for segmenting recording runs. This object is achieved by way of the method in accordance with the features of the independent claims. Further advantageous configurations are specified in the claims worded as dependent claims and in the description and in particular also in the description of the figures. It should be noted that a person skilled in the art combines the individual features with each other in a technologically meaningful manner and thus arrives at further configurations of the invention.

The description here is directed to a novel method for segmenting, or dividing, data collected in a swarm-based manner, or recording runs, that is particularly suitable for subsequently compiling HD maps.

The text that follows presents a novel algorithm for segmenting/dividing journeys into recording runs (“drives”). It also presents the particular advantages of specific types of segmentation/division for specific application of the data processing (initial map production and/or update of HD maps).

The description here is first directed to a method for segmenting a trajectory of a recording run for the swarm-data-based compilation of HD maps, wherein sensor data are acquired along the trajectory during the recording run, and wherein the sensor data can include GNSS measurement data, comprising the following steps:
a) detecting points on the trajectory at which position determination is not possible using GNSS measurement data alone or the accuracy of the position determined using GNSS measurement data alone does not attain a predetermined positioning accuracy, and
b) segmenting the trajectory into multiple segments in such a way that each segment attains a predetermined minimum length and that at least one point detected in step a) is located neither in the start region nor in the end region of each segment.

One step to use data collected in a swarm-based manner in recording runs to create HD maps is aligning, or referencing, or mapping individual recording runs with one another. Referencing, or aligning, means that identical sensor data determined during different recording runs are aligned with one another. Alignment is necessary because all sensor data are subject to measurement errors, or the data are acquired in different coordinate systems during the recording runs (as described above). Customarily, all objects detected during a recording run (for example a set of traffic lights) are assigned to particular vehicle-specific coordinates, which are assigned on the basis of global coordinates determined during the recording run. For example, these global coordinates are determined by means of GNSS. The accuracy of GNSS is limited. It can be in the centimetre range, but this accuracy is often lower, in particular for vehicles in use that are not specifically set up to generate map data. In addition, there are situations in which GNSS signals are screened, as in the situation in a tunnel already described above. In such situations, odometry data are customarily additionally used to determine a global coordinate of a current position of a vehicle. By way of example, odometry data come from wheel speed sensors and steering sensors on vehicles. Such odometry data can be used to update vehicle positions even when GNSS signals are (temporarily) unavailable, and this means that global positions can also be determined then. The use of odometry data in addition to GNSS to determine global positions of a vehicle is required in tunnels, for example. However, this results in position shifts because the odometry data routinely need to be integrated in order to be able to use them for determining global positions.

Measurement errors caused by inaccurate GNSS and/or the use of odometry data may be able to be corrected at least in part by a large volume of processed swarm data when swarm data are used to compile HD maps. In principle, suitable approaches allow high-quality HD maps to be created using swarm data. The redundancy of the information available in swarm data may be able to compensate for individual measurement errors that occur.

Approaches for processing swarm data for producing highly accurate maps are often based on the so-called SLAM method. SLAM stands for Simultaneous Localization and Mapping.

The SLAM method involves all available additional information relating to the surroundings of a vehicle, as determined by sensors, being compared with information that is already available in the form of a map, and the map being improved, or corrected, using the additional information. This means that map data are constantly added to, or corrected, using additional functions determined by sensors. The SLAM approach is comparable to the sensing of the surroundings that is commonly also used by the human brain. As they look at a room in which they are located, a human being knows what the room looks like and what is in the room. There is a kind of virtual map of the room in the head of the human being. Through the perception of the room, the human being automatically adds to their picture of their surroundings, or to the virtual map of the surroundings that the human being has present.

With regard to the processing of swarm data for producing highly accurate maps, the SLAM method is preferably used to obtain mutually aligned travel trajectories, or routes of the individual journeys, that were used to collect the swarm data. The sensor measurements of all sensors of a vehicle are recorded relative to a position of the vehicle when the respective data are determined. Errors in the determination of the position of the vehicle are reflected in the travel trajectory, or the route of the journey of the vehicle. The travel trajectories, or the routes, of the individual recording runs of the data collection can customarily be aligned with one another using the SLAM method. Preferably, landmarks detected by the sensors of the vehicle on different recording runs are assigned to one another and used for referencing/aligning the recording runs to/with one another. In particular, such a step allows the use of swarm data to compile HD maps.

However, the approach using swarm data to create HD maps also presents other new challenges. In order to be able to align journeys with one another, journeys that have covered a certain journey distance are needed. Only then do enough features exist (in particular enough landmarks in the surroundings of the travel trajectory, or the route) that permit referencing, or alignment, of the individual recording runs to/with one another. An upper limit of the journey length is not mandatory. In principle, however, there is an upper limit in order to limit the volume of data packets associated with a recording run that are transported to the central authority by the vehicle.

In preferred variant embodiments, recording runs, or the data packets processed as a recording run, each reflect sections of routes that have a specific route length. This length may be defined by a length (for example in metres or kilometres) in variant embodiments. This length may also be defined by time, so that, for example, a specified time interval on a journey of a recording vehicle is interpreted as a recording run. Such division serves the purpose of keeping the data packets to be processed for recording runs within a specific size range. The division of an actual journey of a recording vehicle along a specific route (for example from Frankfurt to Munich) into individual recording runs, or data packets, for the processing for creating map data can also be referred to as slicing or dividing the recording runs, or data packets. The use of the SLAM method is considerably simplified by the formation of segments of the recording runs in specific length ranges. The formation of segments having suitable properties standardizes the data that can be fed to a SLAM algorithm. This permits more efficient performance of the SLAM algorithm.

Segments of recording runs are preferably formed in such a way that start regions and end regions of adjoining segments partially overlap, or segment regions of overlap in which there are data in both adjoining segments are formed here. This makes it possible to reconnect the segments to one another, or to process them with one another, in later methods for processing the data in the segments.

Suitable, particularly advantageous slicing, or suitable particularly advantageous division and/or segmentation, of recording runs and data packets permits particularly efficient processing of the recording runs and data packets for producing maps. In particular, parallel processing of a large amount of recording runs can be facilitated by suitable slicing, or suitable division/segmentation. Such slicing, or such division, can, for example, also be selected differently depending on the situation. For example, a distinction can be made according to whether a route on a motorway, a country road or in the city is involved.

In principle, there is great interest in the amount of recording runs used for creating map data being within a specific range. At the same time, the frequency with which data is collected in a swarm-based manner, or recording runs, concerning specific route sections are carried out is extremely different. Whereas many vehicles travel on a motorway, for example, and therefore many (potential) recording runs for generating data packets are carried out, journeys are routinely made much less frequently on minor roads. This means that on minor roads there is also a much smaller volume of data.

Suitable slicing, or suitable division/segmentation, of recording runs allows recording runs, or the corresponding data packets, to be well suited to creating HD maps. While it may make sense to use more data to create HD maps for major roads than for minor roads, suitable segmentation allows a selection from a total collected volume of data to be made, which is then used to compile the HD map, and customized coverage of data for compiling the HD map to be achieved.

As already described above, when compiling HD maps from swarm data, a distinction must always be made between first production of the HD map and an update to the HD map (which is required on a regular basis due to changes in routes). There is no map during initial production of an HD map, and data packets from a higher number of recording runs must be combined with one another to create a first (initial) HD map. Updates to HD maps are required on a regular basis because HD maps customarily include a large number of features that can regularly change. Such features can relate to construction sites, for example. Simply due to the high level of detail in HD maps, changes occur more frequently. By way of example, updates require small parts of the map to be replaced. In principle, it is desirable for updates to HD maps to result in as little as possible about the map being changed. This can have advantages, for example, if the map is safey-relevant and needs to be backed up by a review or other measures.

The two different phases, or types, of map production (initial map production and update of HD maps) present different challenges to data processing for processing data obtained with swarm data. These different challenges in particular can be addressed and dealt with by suitably segmenting/dividing the data, or recording runs.

The approach for segmenting recording runs, or the trajectories thereof, that is described here comprises two basic steps: First, points at which GNSS accuracy is poor are detected. In a second step, segments are formed such that neither the start region nor the end region of segments contain such points.

The first step, a) detecting journey sections with poor GNSS measurement data (for example in tunnels), is important, as preferably no segments must be produced whose production involved no GNSS measurement data or only poor GNSS measurement data being obtained. This refers in particular to the start range and the end range of the segments. There should be good GNSS measurement data for the start and end ranges of the segments whenever possible. For example, if there were a segment that contains GNSS measurement data only at the beginning but not at the end of the segment, an odometry drift would generate potentially invalid results for SLAM optimization. The GNSS measurement data are important, both in recording runs relating to specific segments and in the drive data packets belonging to these recording runs, in order to describe a route, which is used in the recording of the data in the data packet by the sensors on the recording vehicle to reference all recorded data in space. In the regions in which there are no GNSS measurement data, this route must be determined purely on the basis of odometry data, determined for example by wheel speed sensors and/or steering angle sensors of the vehicle. Such odometry data can customarily be subject to drift. In order to limit the effect of drifts in the odometry data, it is a great advantage if segments are produced such that at the beginning and end of each segment, or each recording run, there are always GNSS measurement data that can be used to describe the route, and a description of the route is provided only between the beginning and end of each segment solely on the basis of odometry data.

When the method described here refers to segmenting trajectories, what is meant is that all the data collected during the recording run are segmented along the trajectory. Within the Segmentation the data collected during the recording run is used to form respective data packets, associated with sections (segments) of the trajectory, that have a scope that permits good further processability for producing and/or updating HD maps.

The method is particularly advantageous if the minimum length of the segments is defined as greater than 200 metres.

The minimum length of the segments can also be greater, for example 500 metres. The minimum length is preferably chosen such that data storage of the segments is efficiently possible and algorithms for processing the data contained in the segments can work efficiently.

This minimum length corresponds to the route of the recording vehicle taken by the recording vehicle when collecting data. Segments must be of sufficient length to be able to contain enough information. At the same time, the length should not be so long that unnecessarily large volumes of data need to be taken into account to update and process the data.

It is particularly preferred when the trajectory has a starting point and an end point in step b), and so the trajectory is successively segmented into multiple segments from the starting point to the end point according to the minimum length, a segment being combined with an adjacent segment immediately in front and/or behind to form a new segment if a point detected in step a) is located in the start region and/or in the end region.

A data packet collected in a swarm-based manner usually initially comprises data that are recorded during a (complete) journey of a vehicle. For example, a customer vehicle travels from the house of a driver to their workplace. The starting point is then the house. The end point is the workplace. If this route is a total of 10 kilometres long, this route can be initially divided into 20 segments with a length of 500 metres each, for example, using the method described.

What is intended to be described here is in particular a method for providing an HD map from swarm data acquired by customer vehicles, comprising the following steps:
A) receiving data relating to a multiplicity of recording runs with customer vehicles in such a way that a trajectory and sensor data corresponding to the trajectory are acquired for each recording run, the sensor data being able to include GNSS measurement data,
B) segmenting the respective trajectories acquired in step a) into multiple segments (3) in accordance with the method with steps a) and b),
C) assigning segments to predetermined map sections so that multiple groups of segments are formed, each of which corresponds to a map section, with the result that multiple map sections can be created from multiple groups and merged to form a complete localization map, and
D) providing an HD map from the groups formed.

The aim of the method in accordance with steps A) to D) is to create as uniform a data density of acquired swarm data as possible for later compilation and/or update of an HD map. The segmentation described in steps a) and b) provides the prerequisites for this.

Step A) comprises receiving data from recording runs, which were preferably acquired by customer vehicles in a swarm-based manner. These data include in particular a trajectory that describes the route of the recording vehicle during the recording run and other data that were determined by sensors during the recording run. The trajectory in these data has preferably been generated using GNSS measurement data/GNSS measurement signals and is particularly preferably available in global coordinates. The trajectory can preferably be used to attribute a global position to all data acquired during the recording run (for example data relating to objects on the carriageway). However, this global position is subject to errors for the reasons mentioned and against the background of the uncertainties mentioned.

The received recording runs are segmented in accordance with steps a) and b) in step B).

Further, in accordance with step C), each created segment of a recording run is assigned to a map section. The map sections are preferably specified by a firmly defined grid associated with the region to be mapped. All segments produced are added to this grid. The grid of map sections is preferably used to be able to later determine respective recording runs for a specific map section.

Step D) then relates to the actual production of the HD map. In accordance with step D), the preliminary work carried out in steps A) to C) means that the HD map can be created map section by map section, and map sections can also be selectively updated.

The association, or grouping, of segments of recording runs in accordance with map sections also significantly improves the processability of the segments for producing HD maps. A SLAM algorithm for aligning segments with one another can be selectively fed segments of individual map sections or, if necessary, adjacent map sections.

In particular, the association of segments with map sections also greatly increases the possibility of parallelizing data processing for compiling HD maps. SLAM optimization for aligning segments of recording runs can be performed in parallel for various locations predetermined by the grid of map sections.

The association of segments of recording runs with map sections that form a grid also allows a search structure to be set up that can be used to efficiently find segments of recording runs. This can be used, for example, to determine data for an update.

The method is particularly advantageous when an analysis is performed between step A) and step D) to establish whether the number of segments in each group exceeds an upper threshold value or is below a lower threshold value.

In this context, it is preferred when surplus segments in a group are removed if the number of segments in this group exceeds the upper threshold value.

It is also preferred when new segments are inserted into a group if the number of segments in this group is below the lower threshold value.

An upper threshold value can be for example ten segments per group, or for one map section. A lower threshold value can be “five”, for example. In principle, it is desirable that the entire area, or road system, to be mapped be covered as consistently as possible in the form of segments of recording runs. An HD map of consistent quality can then be constructed. This can be achieved by the upper and lower threshold values. Particularly preferably, a system for operating the described method is also configured to request further, if necessary selective, (additional) recording runs if not enough data collected in a swarm-based manner are available in specific regions to be mapped.

Additionally, the method is preferred when step D) providing a localization map comprises creating an initial localization map.

In addition, the method is preferred when step D) providing a localization map comprises updating the initial localization map, only a selected map section being updated.

The described method can be used for both applications and is advantageous, this being especially true due to the grouping of the segments in accordance with map sections.

In addition, it is advantageous when the selected map section is updated (in particular in accordance with step C) such that new segments assignable to this map section are added to the applicable group, and already existing segments are removed from this group.

In particular, it is possible for there to always be, for each map section, enough segments of recording runs with a specific up-to-date status (for example no older than 1 year; in the case of a map section with a construction site, for example no older than 1 week). The effect that can be achieved by this is that a data storage device for the segments of recording runs can always provide recording runs having a predetermined up-to-date status.

In addition, it is preferred when the segments in each group are aligned with one another in step D) in order to form an aligned pose graph.

A pose graph includes all poses of the recording vehicles during the various recording runs and thus permits the data collected in different recording runs to be assigned to one another.

Aligning segments of recording runs with one another is an important step for further processing data from different segments together to then create or update an HD map therefrom. The proposal here is now to first create the segments of the recording runs and then store them in the data storage device in a non-aligned manner (as segmented raw data) in order to then be able to access these segmented raw data for compilation and/or update. This makes it possible to prevent information losses that can occur as a result of aligning the data from being incorporated into the data storage, instead permitting essentially original data, as recorded, to be used when compiling the HD map.

Additionally, it is preferred when all segments obtained in step B) are combined in a data structure and stored in a central data memory, the data structure being designed such that new segments can be inserted and already stored segments can be deleted.

It is particularly preferred when the assigning in step C) is carried out using a kD tree by inserting the centres of the respective segments into the kD tree.

A kD tree or “k-dimensional tree” is a balanced search tree for storing spatial data. It provides the ability to efficiently search for stored data.

This forms an efficient data management structure that allows the acquired raw data for map creation to be advantageously provided in a data delivery, in order to be able to compile and/or update HD maps therefrom later (at any time).

The description here is also intended to be directed to a mapping system for producing HD maps, having
a data collection device for collecting data, segments of recording runs being formed and collected in the data collection device according to the described method in accordance with steps a) and b),
a central data memory for storing segments of recording runs, the central data memory being designed in such a way that new segments can be inserted into the central data memory and already existing segments can be removed from the central data memory, and
a data alignment device for generating an aligned pose graph on the basis of the segments stored in the central data memory.

It should be pointed out that the special advantages and configuration features outlined in connection with the method described above are also applicable and transferable to the mapping system.

The mapping system is preferably operated at a central authority and is used to enable users to be continually provided with the latest HD maps.

The mapping system is in particular also configured to carry out management, storage and processing of segments of recording runs in accordance with steps A) to D) that have been described.

The invention and the technical field of the invention are explained in more detail below on the basis of the figures. The figures show preferred exemplary embodiments, to which the invention is not restricted. It should be pointed out in particular that the figures and in particular the size ratios illustrated in the figures are purely schematic. In the figures:

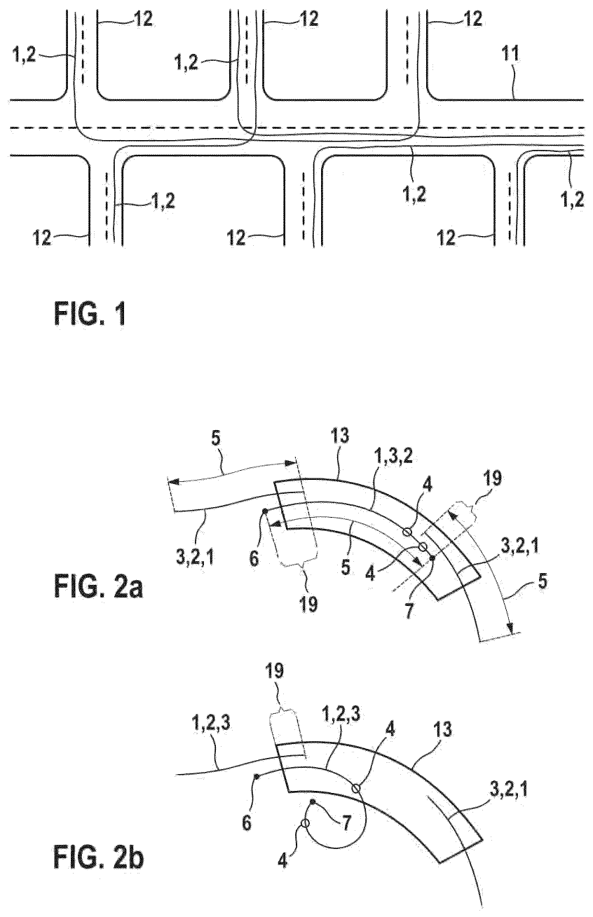

FIG. 1: shows a road system comprising a major road with side streets with schematically depicted recording runs;

FIGS. 2a and 2b: show examples of recording runs in the region of a route through a tunnel;

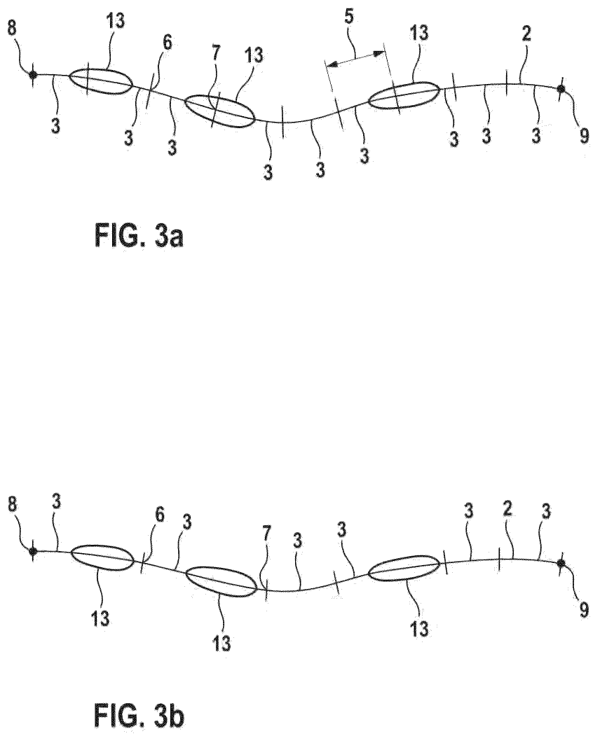

FIGS. 3a and 3b: show examples of the segmentation of a journey of a recording vehicle into recording runs in the region of tunnels;

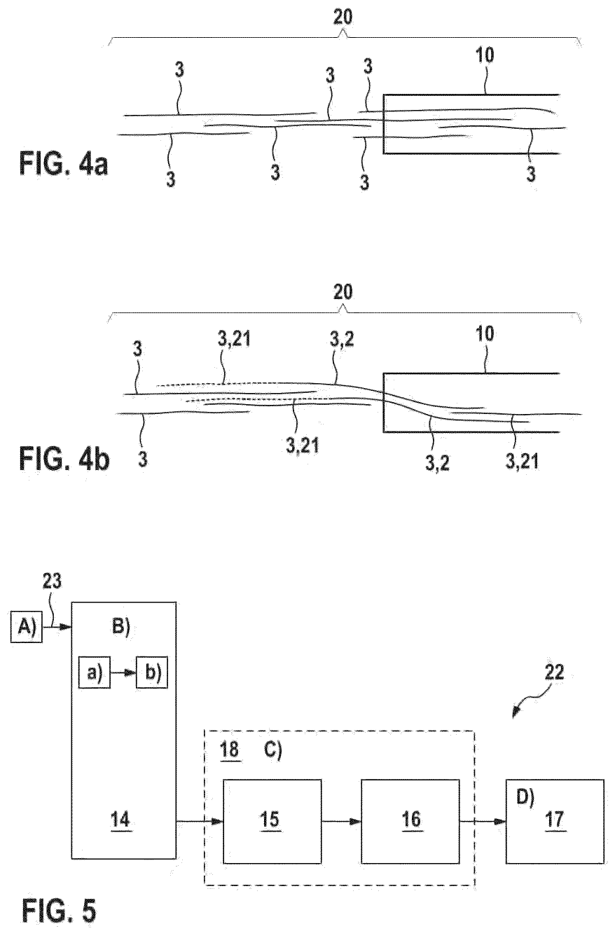

FIGS. 4a and 4b: show examples of which segmented recording runs are used to update a map section; and

FIG. 5: shows a flowchart and a device for compiling HD maps using the method described here.

FIG. 1 shows a road system comprising a major road 11 and minor roads 12 branching off from the major road 11. This is a simple example of a road system that is intended to be mapped, or for which an HD map is to be compiled. Regular traffic by vehicles occurs on the road system. These vehicles are preferably normal customer vehicles that make normal journeys not primarily used to collect data for compiling a map. In fact, journeys are collected by sensors during these journeys, and so the journeys are used as recording runs 2. Each recording run 2 has a trajectory 1 that describes the path the respective vehicle takes during the recording run 2. In FIG. 1 it can be seen that in principle more journeys that can be used as recording runs 2 take place on major roads 11 than on minor roads 12. This is due particularly to the fact that major roads 11 have more traffic than minor roads. It can also be seen that recording runs 2 carried out by normal customer vehicles 2 are not subject to central planning. From the point of view of data gathering, it is more or less random which routes/roads are used. The natural distribution of journeys regularly creates somewhat unfavourable accumulation points of recording runs for compiling HD maps. Common algorithms for processing the swarm data collected in this way are thus supplied with an unnecessarily large amount of data. This costs computing time and increases the effort for map production without creating any added value. The approach proposed here to segment recording runs in accordance with steps a) and b) and to process segmented recording runs further in accordance with steps A), B), C) and D) reduces this problem. All in all, these approaches reduce the computational effort for creating, providing and updating HD maps.

FIGS. 2a and 2b show examples of recording runs 2 that run partially through tunnels 13. FIGS. 2a and 2b show that, in strictly applying the minimum length 5 solely for subdividing a recording run 2 into segments 3, it may be that start regions 6 and/or end regions 7 of segments 3 end in tunnels 13. GNSS reception in tunnels 13 is poor, and so all points on the trajectories 1 of the recording runs in tunnels 13 are points 4 at which accurate GNSS position determination is not possible. An example of such a point 4 lying in an end region 7 of a segment 3 is shown here. This relates to a segment 3 that ends in a tunnel 13.

In a region with poor GNSS measurement data such as this, determination of the trajectory 1 of the recording run 3 is possible (only) using odometry data. FIG. 2b shows (a reinforced illustration of) how a drift in odometry data can have an impact. The segment 3 of the recording run 2, or the trajectory 1 thereof, has a highly erroneous course, which, for example, may be triggered by the drift in odometry data. In order to avoid such effects, it is advantageous for no points 4 with poor GNSS accuracy to be located in particular in a start region 6 and an end region 7 of the segments 3. Start regions 6 and end regions 7 of the segments routinely form regions 19 of overlap with other segments 3. In this case, the segments 3 need to be corelated with other segments 3 in order to perform a SLAM algorithm. High GNSS-determined positional accuracy, which cannot be influenced by the drift in odometry data, is essential here.

FIGS. 3a and 3b now show, along a longer route of a recording run 2, how division of the recording run 2 into segments 3 can be adapted to prevent start regions 6 or end regions 7 of the segments from ending in tunnels 13. FIGS. 3a and 3b thus show in particular the performance of method steps a) and b), performance of which can prevent segments 3 with points 4 in the start region 6 or end region 7 from being produced.

FIGS. 3a and 3b each show a route that runs through a tunnel 13. The route shown in FIGS. 3a and 3b has a starting point 8 and an end point 9 and has been subdivided into segments 3, or into segmented recording runs 2, for better processability for producing HD maps/mapping.

In accordance with FIG. 3a, only a minimum length 5 has been applied to subdivide the route into segments 3. It can be seen that, in individual segments, the start region 6 and/or the end region 7 then end in tunnels 13 and thus have points 4 in the start region 6 and/or in the end region 7 at which there is poor positional accuracy on the basis of GNSS measurement data.

In accordance with FIG. 3b, such segments 3 with a start region 6 or an end region 7 have now been merged with other segments 3 such that there are no longer segments 3 whose start region 6 or whose end region 7 is located in a tunnel 13 and thus in a region where there is poor positional accuracy on the basis of GNSS measurement data.

FIGS. 4a and 4b relate in particular to the described method in accordance with steps A), B), C) and D), in which the method in accordance with steps a) and b) is embedded. FIGS. 4a and 4b show a multiplicity of segments 3 that include data relating to a specific route section 20 and on the basis of which an HD map can be compiled and/or updated. The segments 3 are (as described) parts of recording runs 2. Each of the segments 3 has the associated data obtained during the recording run 2 through that segment 3.

FIGS. 4a and 4b now present the problem that a specific map section 10 of an existing, already compiled HD map is intended to be updated. The segments 3 shown in FIGS. 4a and 4b are stored in a database in which a multiplicity of segments 3 of recording runs 2 with related data are provided. These segments 3 have customarily been collected in a swarm-based manner. The segments 3 stored in the database are customarily provided with a timestamp from when they were recorded. The most up-to-date segments 3 possible are now preferably used to update the map section 10. In addition, it is important to use segments 3 that include information relevant to the map section 10 that is to be updated.

FIG. 4a shows an example of a total set of segments 3 that can be stored in a database in the surroundings of a map section 10 that is to be updated.

FIG. 4b shows an example of new segments 21 that form a subset of the total set of segments 3. For these new segments 21, a distinction is also made between the new segments 21 that are completely outside the map section 10 to be updated, which are shown as a dashed line, and the new segments 21 that relate to the map section 10. Only the new segments 21 shown as a solid line include additional information suitable for updating the map section 10. Preferably, only these new segments 21 are used to update the map section 10.

FIG. 5 schematically shows the method for segmenting recording runs with steps a) and b) and the (superordinate) method for providing the HD map in accordance with steps A) to D) together. While method steps A) to D) describe the superordinate process for producing the HD map, method steps a) and b) relate to the performance of method step B), or are substeps of method step B).

Both methods are carried out using a data processing system 22, which is schematically subdivided into components here. This subdivision is not obligatory. The data processing system 22 may also be structured differently. The illustration is only an example. The components of the data processing system 22 that are shown here are a data collection device 14, a data storage device 18, which is divided again here into a data update unit 15 and a data reduction unit 16, and a data processing device 17.

The data collection device 14 is initially used to collect raw data that can be used for compiling HD maps. Raw data are collected in the field, for example from recording runs 2 with fleet vehicles. During their regular operation, such vehicles preferably record raw data (in a swarm-based manner) that can then be used with the data processing system described here to compile HD maps. Step A) shown here thus preferably takes place outside the data processing system 22. The acquired data are preferably transmitted via a transmission interface 23 (for example a mobile radio connection) from vehicles in the field to the data processing system 22, which is operated by a central authority. The raw data include recording runs initially in non-segmented form. The raw data customarily reflect the collected data simply along the routes that the vehicles in the field have regularly used. This may be, for example, the way to work and/or to the shops for drivers of the vehicles in the field. Method step B) with substeps a) and b) is now used to create, from these raw data, segments that are suitable for further processing the raw data for compiling and/or updating HD maps. The segmentation is described in detail above and associated with the data collection device 14 in the illustration in accordance with FIG. 5.

Data are initially collected independently of the subsequent creation and/or update of the HD map. The segments of recording runs that have been created using the data collection device 14 are deposited in the data storage device 18 in order to be later usable for creating and/or updating HD maps. The data storage device 18 is shown in simplified form here with a data update unit 15 and a data reduction unit 16. The data storage device 18 is for depositing and providing only data, or segments 3, that provide a relevant added value for creating and/or updating an HD map. If, for example, several thousand segments of recording runs over a major road are collected using the data collection device 14, it is routinely not useful to deposit all of these segments in the data storage device in order to later have them available for creating HD maps. The information in the individual segments is then largely redundant. Rather, it is the task of the data storage device 18 to provide segments 3 that are as up to date as possible, which ensures uniform coverage of the roads and routes to be mapped. The data update unit 15 is preferably used to add respective relevant recently added segments. The data reduction unit 16 is preferably used to remove segments that are old, or have been replaced by better, more up-to-date segments. The data storage device 18 is thus preferably configured to always provide the most up-to-date dataset of raw data possible that has the most consistent quality possible over all the roads and routes to be mapped. This is essentially achieved by carrying out method step C), which is associated with the data storage device 18 in the illustration in accordance with FIG. 5.

Suitable segmentation in accordance with steps a) and b) achieves granularity for the data held in the data storage device 18. This granularity increases the efficiency of the data storage device 18. If complete real journeys by vehicles in the field (for example a vehicle user's way to work or the shops) were to be kept in the data storage device 18, these complete real journeys would also have to be added or removed. Segmentation means that it is possible for only particularly relevant sections of a real journey that offer added value for producing and/or updating the HD map to be added to the dataset provided in the data storage device 18. Since individual segments are always created with regions of overlap with adjacent segments in the start region and end region, the segments can be used to produce a complete picture of each individual map section of a system of roads and routes to be mapped at any time.

The dataset provided in the data storage device 18 is accessed by the data processing device 17, which relates to the actual creation and provision of the HD map on the basis of the raw data. The data processing device 17 can preferably be used for creating a (new) HD map. In addition, the data processing device 17 can preferably also be used for updating map sections 10 of an existing HD map.

1. Method for segmenting a trajectory of a recording run for the swarm-data-based compilation of HD maps, sensor data being acquired along the trajectory during the recording run, and the sensor data being able to include GNSS measurement data, comprising the following steps:
a) detecting points on the trajectory at which position determination is not possible using GNSS measurement data alone or the accuracy of the position determined using GNSS measurement data alone does not attain a predetermined positioning accuracy, and
b) segmenting the trajectory into multiple segments in such a way that each segment attains a predetermined minimum length and that at least one point detected in step a) is located neither in the start region nor in the end region of each segment.

2. Method according to claim 1, wherein the minimum length is defined as greater than 200 metres.

3. Method according to claim 1, wherein the trajectory has a starting point and an end point in step b), and so the trajectory is successively segmented into multiple segments from the starting point to the end point according to the minimum length, a segment being combined with an adjacent segment immediately in front and/or behind to form a new segment if a point detected in step a) is located in the start region and/or in the end region.

4. Method for providing an HD map from swarm data acquired by customer vehicles, comprising the following steps:
A) receiving data relating to a multiplicity of recording runs with customer vehicles in such a way that a trajectory and sensor data corresponding to the trajectory are acquired for each recording run, the sensor data being able to include GNSS measurement data,
B) segmenting the respective trajectories acquired in step a) into multiple segments in accordance with the method according to claim 1,
C) assigning segments to predetermined map sections so that multiple groups of segments are formed, each of which corresponds to a map section, with the result that multiple map sections can be created from multiple groups and merged to form a complete localization map, and D) providing an HD map from the groups formed.

5. Method according to claim 4, wherein an analysis is performed between step A) and step D) to establish whether the number of segments in each group exceeds an upper threshold value or is below a lower threshold value.

6. Method according to claim 5, wherein surplus segments in a group are removed if the number of segments in this group exceeds the upper threshold value.

7. Method according to claim 5, wherein new segments are inserted into a group if the number of segments in this group is below the lower threshold value.

8. Method according to claim 4, wherein providing a localization map in step C) comprises creating an initial localization map.

9. Method according to claim 8, wherein providing a localization map in step D) comprises updating the initial localization map, only a selected map section being updated.

10. Method according to claim 9, wherein the selected map section is updated in step D) such that new segments assignable to this map section are added to the applicable group, and already existing segments are removed from this group.

11. Method according to claim 4, when the segments in each group are aligned with one another in step D) in order to form an aligned pose graph.

12. Method according to claim 4, wherein all segments obtained in step B) are combined in a data structure and stored in a central data memory, the data structure being designed such that new segments can be inserted and already stored segments can be deleted.

13. Method according to claim 4, wherein the assigning in step C) is carried out using a kD tree by inserting the centres of the respective segments into the kD tree.

14. Mapping system for producing HD maps, having
a data collection device for collecting data, segments of recording runs being formed and collected in the data collection device in accordance with the method according to claim 1,
a central data memory for storing segments of recording runs, the central data memory being designed in such a way that new segments can be inserted into the central data memory and already existing segments can be removed from the central data memory, and
a data alignment device for generating an aligned pose graph on the basis of the segments stored in the central data memory.
